(19) United States
(12) Patent Application Publication
(10) Pub. No.: US 2025/0076844 A1
(43) Pub. Date: Mar. 6, 2025

(54) Method of Constructing Digital Twin Physical Field of Computer Numerical Control Machine Tool with Double Order Reduction

(71) Applicant: Zhejiang University, Hangzhou (CN)

(72) Inventors: Zhenyu LIU, Hangzhou (CN); Chan QIU, Hangzhou (CN); Guodong SA, Hangzhou (CN); Jianrong TAN, Hangzhou (CN); Boyang CAI, Hangzhou (CN); Kun HUANG, Hangzhou (CN)

(21) Appl. No.: 18/628,592

(22) Filed: Apr. 5, 2024

Related U.S. Application Data
(63) Continuation-in-part of application No. PCT/CN2023/138975, filed on Dec. 15, 2023.

(30) Foreign Application Priority Data
Sep. 6, 2023 (CN) 202311144249.5

(51) Int. Cl. G05B 19/4069; G06F 30/23; G06F 30/27; G06F 119/02

(52) U.S. Cl. CPC G05B 19/4069; G06F 30/23; G06F 30/27; G06F 2119/02

(57) ABSTRACT

A method of constructing a digital twin physical field of a computer numerical control machine tool with double order reduction is provided. A physical field finite element simulation sample data set in a working state sampling space has an order preliminarily reduced to sparse grid node data via an improved K Nearest Neighbor (KNN) algorithm, so that the number of point sets is kept within the real-time rendering capability range of graphic rendering software. A digital twin physical field proxy model is trained using a radial basis function (RBF) to realize reconstruction of the physical field. The proxy model is iteratively optimized using a genetic algorithm to solve the problem of deviation between a proxy physical field model and a real physical model. Finally, the proxy model is deployed to a digital twin system, and the physical field distribution is solved in real time.

### CROSS REFERENCE TO RELATED APPLICATION

This application is a continuation-in-part of International Application No. PCT/CN2023/138975, filed on Dec. 15, 2023, which claims the benefit and priority of Chinese Patent Application No. 202311144249.5 filed with the China National Intellectual Property Administration on Sep. 6, 2023, the disclosure of which is hereby incorporated by reference in its entirety.

### TECHNICAL FIELD

The present disclosure relates to a method of constructing a finite element physical field of a computer numerical control machine tool, and in particular to a method of constructing a digital twin physical field of a computer numerical control machine tool with double order reduction.

### BACKGROUND

In the process of industrial production operation and maintenance guarantee, the digital twin technology realizes physical performance mapping in a virtual space to feed back the working state of a device by making full use of physical model to fuse online real-time data and historical data such as test experiments, and integrating a multidisciplinary and multi-performance simulation process. In order to fully reflect the spatial distribution law of a plurality of physical properties of an industrial device, the physical property state of the device is usually simulated and analyzed by using a numerical method such as a finite element.

Due to the complexity of industrial production environment, only a small amount of data information can be obtained using sensors in the industrial production process. In the monitoring of the operating state, it is difficult for the time-consuming finite element analysis method to meet the real-time requirements, which cannot present the key physical properties synchronously in the working process of the machine tool in real time. Therefore, there is an urgent need for a digital twin system that can fit the physical field in real time, so as to realize the visual monitoring of the physical properties of the device.

The calculation speed of the twin system is closely related to the hardware calculation ability, the algorithm complexity and the model complexity. For solving physical field problems in the scenarios having a large number of data sets, a suitable proxy model can be used to fit and solve the physical field, thereby meeting the requirement for fast and accurate solution of the digital twin system. As a real-time fitting method of the physical field state, the proxy model can present the spatial distribution of the key physical properties of products when being driven by time sequence data and environmental data. Taking physical parameters as input, the proxy model can solve a three-dimensional field in a few seconds, thus replacing the time-consuming finite element calculation.

The model order reduction method based on the radial basis function can satisfy the requirement that the proxy model carries out solution to a certain extent. However, for the common virtual simulation software at present, the real-time rendering ability of the twin system should be taken into account by the constructed proxy model. Both the communication interface between the proxy model and the software, and the real-time rendering ability of the software limit the number of model nodes. However, the result of a low-quality grid volume proxy model is often poor in accuracy, thus causing a contradiction between the number of grids and the accuracy in common proxy models at present.

### SUMMARY

In order to solve the problems existing in the background, the present disclosure provides a method of constructing a digital twin physical field of a computer numerical control machine tool with double order reduction. The method of the present disclosure can overcome the shortcomings of the existing methods, realize the real-time stable communication between the digital twin system and the proxy model, the triangle mesh rendering of the virtual and real mirror image mapping and the real-time simulation of the physical field, and reduce deviation between the physical field model and the real physical model.

In order to achieve the above purpose, the technical scheme of the present disclosure is as follows:
S1: according to working state parameters of the computer numerical control machine tool, establishing a finite element analysis grid model of the computer numerical control machine tool, establishing a working state sampling space of the computer numerical control machine tool, and constructing a physical field finite element simulation sample data set in the working state sampling space;
S2: according to the physical field finite element simulation sample data set, obtaining a sparse grid model and simulation data corresponding to grid nodes of the sparse grid model by using an improved K nearest neighbor algorithm to preliminarily reduce an order of simulation data of the finite element analysis grid model;
S3: according to the sparse grid model and the simulation data corresponding to the grid nodes of the sparse grid model, establishing a digital twin physical field proxy model by using a radial basis function, and establishing a mapping relationship between a grid node and sampling data acquired by a sensor of a key sampling point;
S4: verifying virtual and real consistency of the digital twin physical field proxy model and real sample data of the computer numerical control machine tool, and if the verification fails, optimizing the digital twin physical field proxy model until a verified digital twin physical field proxy model is obtained and deployed in a digital twin system;
S5: inputting real-time sensing data into the digital twin system, and obtaining a physical field distribution through real-time solution using the digital twin physical field proxy model in the digital twin system based on the input real-time sensing data in combination with the mapping relationship between the grid node and the sampling data acquired by the sensor of the key sampling point.

According to the present disclosure, the order of a sample data set is preliminarily reduced to form sparse grid node data using an improved K Nearest Neighbor (KNN) algorithm in combination with the finite element solution result by the method of constructing the physical field proxy model with double order reduction, so that the number of point sets is kept within the real-time rendering capability range of graphic rendering software. A proxy model is training using a radial basis function (RBF) to realize reconstruction of the physical field. According to a genetic algorithm, the proxy model is iteratively optimized. For the proxy model with large deviation after convergence, the scheme of reconstructing the proxy model is opted. Thus, the real-time running data-driven virtual-real mirror mapping physical field simulation is realized

Compared with the prior art and the method, the present disclosure has the following beneficial effects.

According to the present disclosure, the physical field model is preliminarily reduced in order by using the K nearest neighbor algorithm integrating boundary conditions, so as to prevent the physical field boundary fitting result from deviating towards the center. The dense grid point cloud features are reduced in order to the physical information values of each point of triangle mesh of the sparse grid volume, so that the number of grid points is kept within the real-time rendering capability range of the graphic rendering software.

According to the present disclosure, after the physical field grid model is preliminarily reduced in order, the mapping relationship between all the cells of the grid and the sampling data of the sensor of the key sampling points is established through the radial basis function, so that the distribution of physical attributes of the whole physical field is deduced reversely according to different boundary condition information.

According to the present disclosure, the proxy model is iteratively optimized through the genetic algorithm, and the proxy model with large deviation after convergence is reconstructed, which reduces the deviation between the results of the proxy model and the real physical model, thereby improving the optimization efficiency of the proxy model.

To sum up, the present disclosure achieves the construction of the physical field proxy model suitable for the digital twin system, thereby realizing the real-time solution and simulation of the physical fields of key components in the industrial production process.

### BRIEF DESCRIPTION OF THE DRAWINGS

FIG. 1 is a general flow diagram of a spindle of a grinder according to an example of the present disclosure.

FIG. 2 is a schematic diagram of a process of preliminarily reducing the order of a physical field model by using a K nearest neighbor algorithm with fused boundary conditions in an implementation of the present disclosure.

FIG. 3 is a schematic diagram of a process of judging the virtual and real consistency of a digital twin physical field model in an implementation of the present disclosure.

FIG. 4 is an algorithm flow chart of iterative optimization of a digital twin physical field proxy model using a genetic algorithm in an implementation of the present disclosure.

FIG. 5A, FIG. 5B and FIG. 5C are schematic diagrams of a process of optimizing a digital twin physical field proxy model using a genetic algorithm to obtain an optimal solution in an implementation of the present disclosure.

### DETAILED DESCRIPTION OF THE EMBODIMENTS

The present disclosure will be further explained with the accompanying drawings and specific examples.

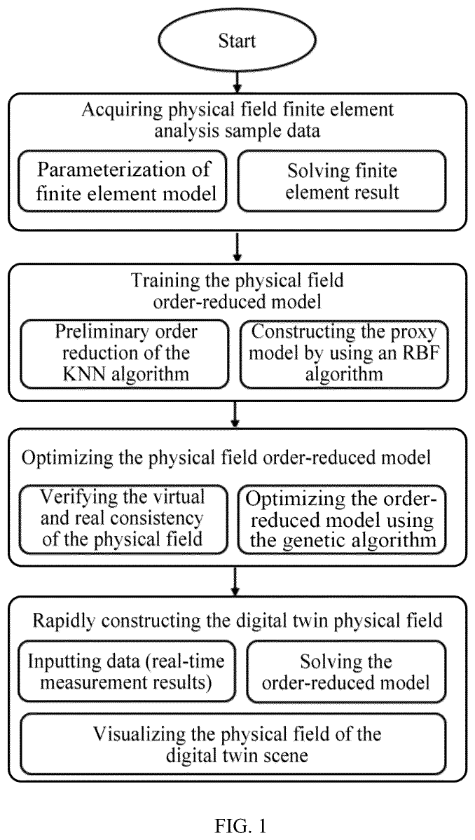

As shown in FIG. 1, the embodiment of the present disclosure is illustrated by taking a flat forming grinder as an example.

The geometric structure of a computer numerical control grinder model is complex, so that it is difficult to directly construct the whole physical field model of the grinder, and it is impossible to highlight the deformation under stress of key components in the working process. The grinding head and the spindle are the main components that directly affect the machining accuracy in the actual machining process. The components of the spindle are extracted from the computer numerical control grinder model for analyzing the boundary condition and constructing the physical field model.

From the point of view of physical field analysis, the physical field of the spindle of the computer numerical control grinder is divided into two parts: a structural field and a temperature field. The main parameter variables include a grinding depth aₚ, a grinding head speed Vₛ and a feed speed V_{w}. The grinding force acting on the grinding wheel and the workpiece is divided into two components, that is, the normal component Fₙ and the tangential component Fₜ of the grinding force. The grinding force can be divided into two parts: a cutting deformation force and a sliding force, and the cutting deformation force can be divided into a cutting forming force and a ploughing force.

The bounding volume condition of the temperature field is mainly that the grinding wheel spindle is equipped with rolling bearings and grinding wheels at the front and back. The heating condition of the rolling bearings is mainly affected by three factors: the model of the rolling bearings, the type of lubricants and the stress of the rolling bearings. The heat flux of the grinding wheel mainly includes the heat flux q_{w} entering the workpiece, the heat flux q_{ch} removed by cutting, the heat flow qₛ transferred to the grinding wheel, and the heat flow q_{f} transferred to the fluid by convection.

As shown in FIG. 1, the method includes steps S1-S5.

In step S1, in the off-line stage, according to working state parameters of the computer numerical control machine tool, a finite element analysis grid model of the precision computer numerical control machine tool is established, a working state sampling space of the computer numerical control machine tool is established, and a physical field finite element simulation sample data set in the working state sampling space is constructed.

The physical field includes a structural field and a temperature field in the physical field finite element simulation sample data set, and objects corresponding to the finite element simulation sample data are key components of the computer numerical control machine tool.

First, the working state sampling space of the computer numerical control machine tool is established according to the working state parameters of the computer numerical control machine tool (such as working time, spindle speed, feed quantity, vibration and ambient temperature, etc.), the working state of the computer numerical control machine tool is sampled in the working state sampling space to obtain machine tool sampling points, and then parameterization of simulation analysis is carried out on the machine tool in the working state corresponding to each of the machine tool sampling points to obtain the physical field finite element simulation sample data set.

In the specific implementation, the parameters that affect the physical properties of the target in the working state are divided into two aspects: time sequence parameters and environmental parameters. Based on the above two kinds of parameters, the working state parameters are constructed, and parameterized finite element analysis is carried out, where the time sequence parameters are variables such as execution time and movement speed that can be extracted from time sequence data. The environmental parameters are variables such as temperature and vibration sensed by the sensor. The working state parameter p can be characterized in a form of a vector: p=[a₁, . . . , aₘ, c₁, . . . , cₙ]^{T}, where a₁, . . . , aₘ are m time sequence parameters, and c₁, . . . , cₙ are n environmental parameters. In addition, it is necessary to determine the value range of each parameter in the working state, so as to determine the sampling space p∈A₁× . . . . Aₘ×C₁× . . . ×Cₙ, where Aₘ and Cₙ denote the value range of the time sequence parameters and the environmental parameters in the working state, respectively, and each additional parameter is equivalent to an additional dimension in the parameter space. Aₘ denotes the value range of the parameter aₘ, and Cₙ denotes the value range of the parameter cₙ. Thereafter, according to the determined working state parameters, a parameterized finite element model is established, and the working state parameters as boundary conditions are loaded on the finite element model. At the same time, the grid division of the finite element model keeps uniform under each boundary condition. Keeping the grid division of the finite element model uniform provides a constant spatial distribution of unit nodes for the construction of the proxy model, thus simplifying the selection of key sampling points. Some key values are selected in the sampling space of the working state parameters, based on which it is solved using parameterization of the finite element model under multi-boundary conditions in the finite element analysis tool. In this embodiment, the temperature field of the spindle system is solved by analyzing the stress and the thermal boundary conditions of the spindle system.

For each triangle mesh of the finite element analysis grid model of the computer numerical control machine tool, each edge of the triangle mesh consists of two directed half-edges to represent its plane structure.

S2: according to the physical field finite element simulation sample data set, a sparse grid model and simulation data corresponding to grid nodes of the sparse grid model are obtained using an improved K nearest neighbor algorithm (that is, the K nearest neighbor algorithm fusing the boundary features of the grid model) to preliminarily reduce an order of simulation data of the finite element analysis grid model.

S2 specifically includes steps S21-S22.

In step S21, according to the physical field finite element simulation sample data set, all triangle meshes in the finite element analysis grid model are mapped to a three-dimensional space, and then it is determined whether each of the triangle meshes is on the surface of a grid volume or inside the grid volume, so that each grid node is determined to be an internal node of the grid volume or a surface node of the grid volume, and the sparse grid model is obtained. In the specific implementation, a triangle mesh is used to construct a half surface S with vertex data, and it is determined whether the triangle mesh is on the surface of the grid volume according to the number of use times/that the half surface S is used in all grid cells F, which satisfies t=>E∩s. When the number of use times/is equal to 1, the nodes corresponding to the half surface are surface nodes of the grid volume, and if the number of use times/is greater than 1, the nodes are internal nodes of the grid volume.

In step S22, physical attribute values corresponding to the internal nodes of each grid volume and the surface nodes of each grid volume are calculated and updated using the K nearest neighbor algorithm, and simulation data corresponding to each grid node in the sparse grid model is obtained, wherein weights of the internal node of the grid volume and the surface node of the grid volume are different.

Specifically, for the spindle of the grinder system, sparse gridding division is carried out on the spindle model by using an Ansys software. In order to keep the number of divided grid points within the real-time rendering capability range of the digital twin system, the number of divided grid points is 6750, and the number of original grid points is 24964. The vertex set of all the surface grid triangles after deduplication is denoted as Dₒ. Assuming that the grid points are uniformly distributed, for each sparse grid node Qᵢ, n nodes in its neighborhood are calculated by the Euclidean distance, which is denoted as D_{q}.

For the internal nodes of the grid volume, that is, D_{q}∩Dₒ=Ø, Qᵢ is an internal node. Assuming that n nodes near Qᵢ have physical information values {p₁, p₂ . . . pₙ} corresponding to their physical fields, and in this embodiment, n=15, the distance between the nodes and node Qᵢ is {d₁, d₂ . . . dₙ}, and the calculation of corresponding point values of the physical fields of Qᵢ follows the following formula:

$${p}_{i} = \frac{1}{n} \sum ( \frac{{p}_{j}}{{d}_{j}} / \sum \frac{1}{{d}_{k}} ) .$$

For the surface nodes of the grid volume, if D_{q}∩Dₒ is not null and the number is denoted as u, Qᵢ is an edge node in the sparse grid. According to the number u of points close to Qᵢ, the influencing weights of n neighbors are allocated. The calculation of the corresponding point value of the physical field of Q; follows the following formula:

$${p}_{i} = \frac{u}{{n}^{2}} \sum ( \frac{{p}_{out}}{{d}_{out}} / \sum \frac{1}{{d}_{k}} ) + \frac{n - u}{{n}^{2}} \sum ( \frac{{p}_{in}}{{d}_{in}} / \sum \frac{1}{{d}_{k}} ) ,$$

where pₒᵤₜ is a physical information value of a surface node of the grid volume in neighbors close to Qᵢ, dₒᵤₜ is the distance between the surface node of the grid volume in the neighbors close to Qᵢ and Qᵢ, dₖ is a distance between a k^{th} neighbor close to Qᵢ and Qᵢ, pᵢₙ is a physical information value of an internal node of the grid volume in the neighbors close to Qᵢ, and din is a distance between the internal node of the grid volume in the neighbors close to Qᵢ and Qᵢ.

In step S3, in the online stage, according to the sparse grid model and the simulation data corresponding to the grid node of the sparse grid model, a digital twin physical field proxy model is established by using a radial basis function. An interpolation kernel function of the radial basis function uses a Gaussian kernel function. The second order reduction of simulation data is completed. A mapping relationship between the grid node and sampling data acquired by a sensor of a key sampling point is established. Through this mapping relationship, the physical attribute distribution of the whole physical field can be deduced reversely from the data required by the sensors of discrete key sampling points.

Specifically, assuming that there are N input grid nodes with physical field analysis results in the multidimensional space, the corresponding physical attribute value of each grid node at the spatial coordinates is dᵢ. Through the RBF interpolation, a mapping function ƒ(x)=dᵢ, i=1, 2, . . . . N satisfying the following conditions is found. The digital twin system is updated by the sensor data-driven model. The input variables in the training sample data set are usually a subset of the control variables. Using the response values of some nodes in the physical field as input, the mapping relationship ƒ(x) between these discrete measuring points and all spatial nodes is constructed to realize the reconstruction of the physical field. The interpolation function t(x) based on the radial basis is defined as the linear combination of the basis function and follows the following formula:

$$t ( x ) = {\sum }_{i = 1}^{N} {w}_{i} φ ( ‖ x - {x}_{i} ‖ ) ,$$

where wᵢ is an interpolation coefficient, φ( ) is a kernel function, x is an interpolation point, xᵢ is an interpolation center, and ∥x−xᵢ∥ is a distance from the interpolation point to the interpolation center.

The RBF interpolation coefficient matrix W is solved based on the training sample data set, W=ϕ⁻¹y, where ϕ is a radial basis function matrix, and y is a training sample matrix. The physical field proxy model is trained by taking the spatial coordinates and physical parameter values of the sparse grid nodes sampled many times as input values, and the corresponding physical values of each node are output by inputting variable parameters at different times.

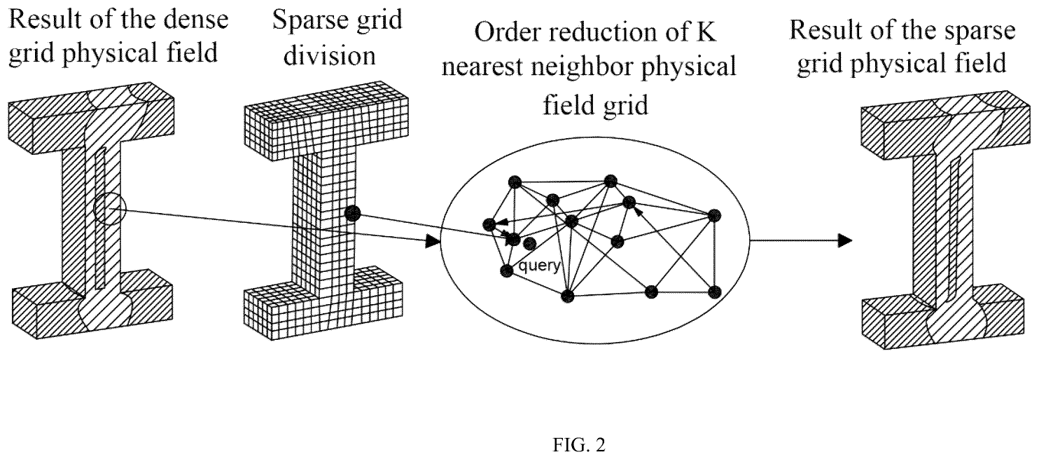

Because the position where sensors can be directly arranged on the spindle is limited, and the main heat flow comes from two areas linked with the bearings, the boundary conditions are updated based on samples taken from the outside of the bearings at both ends of the spindle. By inputting the corresponding temperature of t=[t(x₁), t(x₂)]^{T} in the front and back positions x=[x₁, x₂]^{T} into the proxy model, in which x₁ and x₂ denote the positions of bearings at both ends of the spindle, the temperature field of the whole spindle system is solved, as shown in FIG. 2. In FIG. 2, different densities of the diagonal lines represent different physical field numerical values.

In step S4, virtual and real consistency of the digital twin physical field proxy model and real sample data of the computer numerical control machine tool (the signal data acquired by the sensor corresponding to the real components) is verified, and if the verification fails, the digital twin physical field proxy model is optimized until a verified digital twin physical field proxy model is obtained and deployed in a digital twin system;

S4 specifically includes the steps S41-S43.

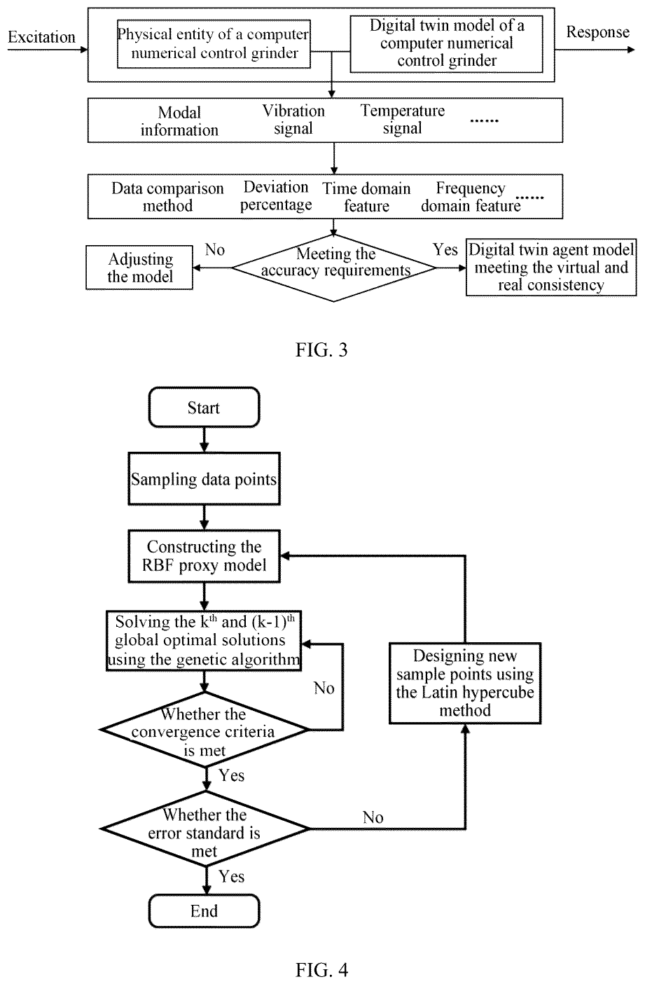

In step S41, virtual and real consistency of the physical quantity simulation data dataₛ acquired in the digital twin physical field proxy model and a real model of the computer numerical control machine tool (that is, the signal data dataₑ acquired by the sensor corresponding to the real components) is verified. The smaller the deviation, the stronger the consistency between the virtual and real mirror images of the physical field, and the more accurate the proxy model result, as shown in FIG. 3. If the verification passes, the current digital twin physical field proxy model is taken as the final digital twin physical field proxy model, otherwise, S42 is executed.

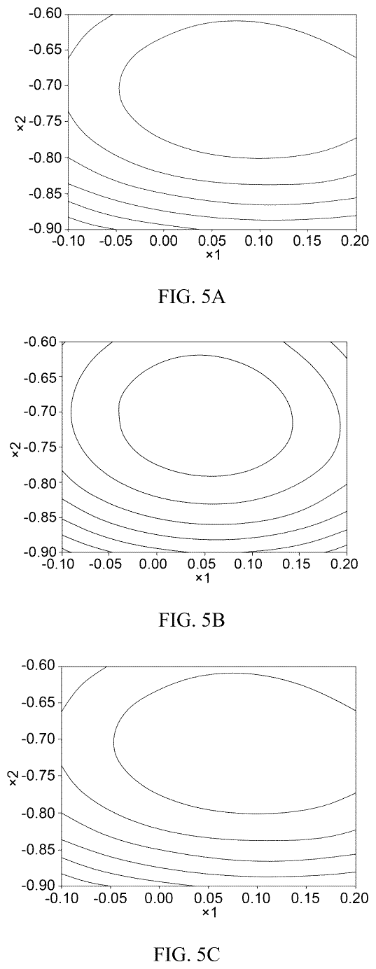

In step S42, as shown in FIG. 4, FIG. 5A, FIG. 5B and FIG. 5C, in which FIG. 5A is the actual contour line, FIG. 5B is the contour line of the RBF proxy model, and FIG. 5C is the contour line of a dynamic optimization proxy model. The digital twin physical field proxy model is iteratively optimized by using a genetic algorithm with global optimization ability, in which the population size is set to 50, the termination evolution algebra of the algorithm is 100, and the crossover probability is 0.5. The optimized digital twin physical field proxy model is obtained, in which it is determined whether it has converged by the relative error of the real objective function value corresponding to the possible optimal solution of the k^{th} iteration and the (k−1)^{th} iteration in the iterative optimization process. The virtual and real consistency of the optimized digital twin physical field proxy model is verified, if the verification passes, the current digital twin physical field proxy model is taken as a final digital twin physical field proxy model, and if the verification fails, S43 is executed. In the specific implementation, when the relative error of the objective function value of the real model and the proxy model corresponding to the possible optimal solution of the k^{th} iteration exceeds the preset threshold, it is considered that the verification fails.

S43: the working state of the computer numerical control machine tool is re-sampled in the working state sampling space by using a Latin hypercube sampling method to obtain the machine tool sampling points, and then the physical field finite element simulation sample data set is obtained, and S2, S3 and S41 are repeated until the final digital twin physical field proxy model is obtained and deployed in the digital twin system.

S5: real-time sensing data is input into the digital twin system through socket communication, and in combination with a mapping relationship between the sampling data acquired by the grid node and the sensor of the key sampling point, a physical field distribution is obtained in the digital twin system through real-time solution of the digital twin physical field proxy model. The spatial coordinates of each node of the grid model are recorded in the digital twin system, and real-time fitting of the physical field is performed according to the solved physical field distribution and the spatial coordinates of the corresponding nodes to realize visual output.

In this embodiment, in the off-line stage, the boundary conditions of the spindle system of the computer numerical control grinder are analyzed, and the sample points are acquired according to the Latin hypercube sampling method. The node data is derived by physical analysis in the finite element simulation software. Thereafter, the K nearest neighbor algorithm is used to preliminarily reduce the order of the physical field sample data to the grid volume data with the specified number of nodes. The physical field proxy model is solved using the radial basis function based on the preliminary order reduced data. After the physical field proxy model is obtained, the parameter values of the test node are input into the proxy model, and transmitted to the digital twin platform through socket communication. The twin software carries out physical field fitting on the received grid node parameters. In the online stage, the data required by the senor at the specified position is input into the proxy model, and the whole physical field data of the spindle is deduced reversely. By comparing the solution value of the proxy model of the sampling point position with the real value measured by the actual sensor, the proxy model is iteratively optimized by using a genetic algorithm, so as to reduce the deviation between the physical attribute value solved by the twin system proxy model and the real value. Compared with the existing methods, the proxy model solving method provided by the present disclosure can meet the requirements of different rendering capabilities of the digital twin system, ensure the solving accuracy of the physical field at the same time, realize the real-time simulation of the physical field of virtual and real mirror mapping, and provide a model for the data information of the digital twin physical field.

Finally, it should be explained that the above embodiments and illustrations are only used to explain the technical scheme of the present disclosure, rather than limit the technical scheme. Those skilled in the art should understand that the technical scheme of the present disclosure can be modified or substituted by equivalents. All the modifications or substitutions made without departing from the spirit and scope of the technical scheme of the present disclosure should be included in the scope of protection of the claims of the present disclosure.

What is claimed is:

1. A method of constructing a digital twin physical field of a computer numerical control machine tool with double order reduction, comprising:
S1: according to working state parameters of the computer numerical control machine tool, establishing a finite element analysis grid model of the computer numerical control machine tool, establishing a working state sampling space of the computer numerical control machine tool, and constructing a physical field finite element simulation sample data set in the working state sampling space;
S2: according to the physical field finite element simulation sample data set, obtaining a sparse grid model and simulation data corresponding to grid nodes of the sparse grid model by using an improved K nearest neighbor algorithm to preliminarily reduce an order of simulation data of the finite element analysis grid model;
S3: according to the sparse grid model and the simulation data corresponding to the grid nodes of the sparse grid model, establishing a digital twin physical field proxy model by using a radial basis function, and establishing a mapping relationship between a grid node and sampling data acquired by a sensor of a key sampling point;
S4: verifying virtual and real consistency of the digital twin physical field proxy model and real sample data of the computer numerical control machine tool, and when the verification fails, optimizing the digital twin physical field proxy model until a verified digital twin physical field proxy model is obtained and deployed in a digital twin system; and
S5: inputting real-time sensing data into the digital twin system, and obtaining a physical field distribution through real-time solution using the digital twin physical field proxy model in the digital twin system based on the input real-time sensing data in combination with the mapping relationship between the grid node and the sampling data acquired by the sensor of the key sampling point.

2. The method of constructing the digital twin physical field of the computer numerical control machine tool with double order reduction according to claim 1, wherein in S1, first, the working state sampling space of the computer numerical control machine tool is established according to the working state parameters of the computer numerical control machine tool, a working state of the computer numerical control machine tool is sampled in the working state sampling space to obtain machine tool sampling points, and then parameterization of simulation analysis is carried out on the machine tool in the working state corresponding to the machine tool sampling points to obtain the physical field finite element simulation sample data set.

3. The method of constructing the digital twin physical field of the computer numerical control machine tool with double order reduction according to claim 1, wherein in S1, for each triangle mesh of the finite element analysis grid model of the computer numerical control machine tool, each edge of the triangle mesh consists of two directed half-edges.

4. The method of constructing the digital twin physical field of the computer numerical control machine tool with double order reduction according to claim 1, wherein S2 comprises:
S21: according to the physical field finite element simulation sample data set, mapping all triangle meshes in the finite element analysis grid model to a three-dimensional space, and then determining that each of the triangle meshes is on a surface of a grid volume or inside the grid volume to determine whether each grid node is an internal node of the grid volume or a surface node of the grid volume, and obtain the sparse grid model; and
S22: obtaining simulation data corresponding to each grid node in the sparse grid model by using a K nearest neighbor algorithm to calculate and update physical attribute values corresponding to the internal nodes of each grid volume and the surface nodes of each grid volume, wherein weights of the internal nodes of the grid volume and the surface nodes of the grid volume are different.

5. The method of constructing the digital twin physical field of the computer numerical control machine tool with double order reduction according to claim 1, wherein S4 comprises:
S41: verifying virtual and real consistency of the digital twin physical field proxy model and a real model of the computer numerical control machine tool, and when the verification passes, taking a current digital twin physical field proxy model as a final digital twin physical field proxy model, or when the verification fails, executing S42;
S42: iteratively optimizing the digital twin physical field proxy model by using a genetic algorithm to obtain an optimized digital twin physical field proxy model, verifying virtual and real consistency of the optimized digital twin physical field proxy model, when the verification passes, taking a current digital twin physical field proxy model as the final digital twin physical field proxy model, or when the verification fails, executing S43; and
S43: re-sampling the working state of the computer numerical control machine tool in the working state sampling space by using a Latin hypercube sampling method to obtain the machine tool sampling points, and then obtaining the physical field finite element simulation sample data set, and repeating S2, S3 and S41 until the final digital twin physical field proxy model is obtained and deployed in the digital twin system.

6. The method of constructing the digital twin physical field of the computer numerical control machine tool with double order reduction according to claim 1, wherein in S1, the physical field comprises a structural field and a temperature field in the physical field finite element simulation sample data set, and objects corresponding to finite element simulation sample data are key components of the computer numerical control machine tool.

7. The method of constructing the digital twin physical field of the computer numerical control machine tool with double order reduction according to claim 1, wherein an interpolation kernel function of the radial basis function is a Gaussian kernel function.
